(19) United States
(12) Patent Application Publication
(10) Pub. No.: US 2008/0209324 A1
(43) Pub. Date: Aug. 28, 2008

(54) PSEUDO DRAG-AND-DROP OPERATION DISPLAY METHOD, COMPUTER PROGRAM PRODUCT AND SYSTEM BASED ON THE SAME

(75) Inventor: Hirochika MATSUO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: ants Inc., Tokyo (JP)

(21) Appl. No.: 11/947,710

(22) Filed: Nov. 29, 2007

Related U.S. Application Data
(63) Continuation-in-part of application No. PCT/JP2006/310704, filed on May 29, 2006.
Application No. PCT/JP2006/310704 is a continuation-in-part of application No. PCT/JP2006/310705, filed on May 29, 2005.

(30) Foreign Application Priority Data
Jun. 2, 2005 (JP) 2005-163097
Jun. 30, 2005 (JP) 2005-192235

(51) Int. Cl. G06F 3/048

(52) U.S. Cl. 715/719; 715/769

(57) ABSTRACT

A computer-implemented method is provided for displaying a pseudo drag-and-drop operation of an object from a window of a Web browser out of the Web browser's window on a desktop of a computer system, wherein a first swf file is played by a Flash Player® upon a request by the Web browser to provide a particular content within the Web browser's window, and the object is at least one part of the particular content. The method comprises: detecting a click event on the object of the particular content; identify a second swf file in connection with the first swf file; requesting the Flash Player® to play the second swf file in response to the detection of the click event, the played second swf file providing an alternative object, the alternative object having an appearance same as the object displayed within the Web browser's window; displaying the alternative object at a position of a mouse pointer upon the detection of the click event, the displayed alternative object being dragged by the pointer of the mouse; and moving the alternative object in accordance with the mouse pointer until a drop event is detected.

### CROSS REFERENCE TO RELATED APPLICATIONS

This application is: a continuation-in-part (CIP) of International Application No. PCT/JP2006/310704, filed May 29, 2006, which claims the priority of Japanese Application No. 2005-163097, filed Jun. 2, 2005; and a CIP of an International Application No. PCT/JP2006/310705, filed May 29, 2006, which claims the priority of Japanese Application No. 2005-192235, filed Jun. 30, 2005. All of the above-referenced applications are incorporated by reference herein.

### BACKGROUND OF THE INVENTION

This invention relates to a computer-implemented method for displaying a pseudo drag-and-drop operation of an object from a window of a Web browser such as an Internet Explorer® of Microsoft Corporation out of the Web browser's window on a desktop of a computer system, by the use of a Flash®-based user interface displayable on the desktop independently of the Web browser. This invention also relates to a computer program product and a system both based on the method.

“Flash®” technology of Adobe Systems Incorporated has become a popular one for providing animation or movie for web pages; for more information about Flash®, see Adobe Systems Incorporated's web site (http://www.adobe.com/).

### SUMMARY OF THE INVENTION

It is an object of the present invention to provide implement a pseudo drag-and-drop operation by using a Flash®-based user interface independently of normal Web browsers or web pages.

According to one aspect of the present invention, a computer-implemented method is provided for displaying a pseudo drag-and-drop operation of an object from a window of a Web browser out of the Web browser's window on a desktop of a computer system, wherein a first swf file is played by a Flash Player® upon a request by the Web browser to provide a particular content within the Web browser's window, and the object is at least one part of the particular content. The method comprises: detecting a click event on the object of the particular content; identify a second swf file in connection with the first swf file; requesting the Flash Player® to play the second swf file in response to the detection of the click event, the played second swf file providing an alternative object, the alternative object having an appearance same as the object displayed within the Web browser's window; displaying the alternative object at a position of a mouse pointer upon the detection of the click event, the displayed alternative object being dragged by the pointer of the mouse; and moving the alternative object in accordance with the mouse pointer until a drop event is detected.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a block diagram schematically showing a typical computer system in accordance with an embodiment of the present invention;

FIG. 2 is a diagram schematically showing a system for displaying a Flash®-based user interface in accordance with an embodiment of the present invention;

FIG. 3 is a flowchart schematically showing a computer-implemented method for displaying a Flash®-based user interface in connection with the system of FIG. 2;

FIG. 4 is a view showing a set of Flash®-based user interface examples;

FIG. 5 is a flowchart schematically showing a computer-implemented method for displaying a partially-transparent Flash®-based user interface in connection with the system of FIG. 2;

FIG. 6 is a view schematically showing the computer-implemented method of FIG. 5;

FIG. 7 is a view schematically showing a communication between a gadget and a core program in accordance with an embodiment of the present invention;

FIG. 8 is a view schematically showing an update process of the core program in accordance with an embodiment of the present invention;

FIG. 9 is a view schematically showing a communication between a gadget and a Web browser and processes in connection therewith in accordance with an embodiment of the present invention;

FIG. 10 is a view schematically showing an example of a computer-implemented method for displaying a pseudo drag-and-drop operation in accordance with an embodiment of the present invention;

FIG. 11 is a view schematically showing processes for displaying a screen saver in accordance with an embodiment of the present invention;

FIG. 12 is a view schematically showing an exemplary system comprising an advanced television in accordance with an embodiment of the present invention;

FIG. 13 is a block diagram schematically showing the advanced television of FIG. 12; and

FIG. 14 is a view schematically showing an operation of the advanced television of FIG. 12.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

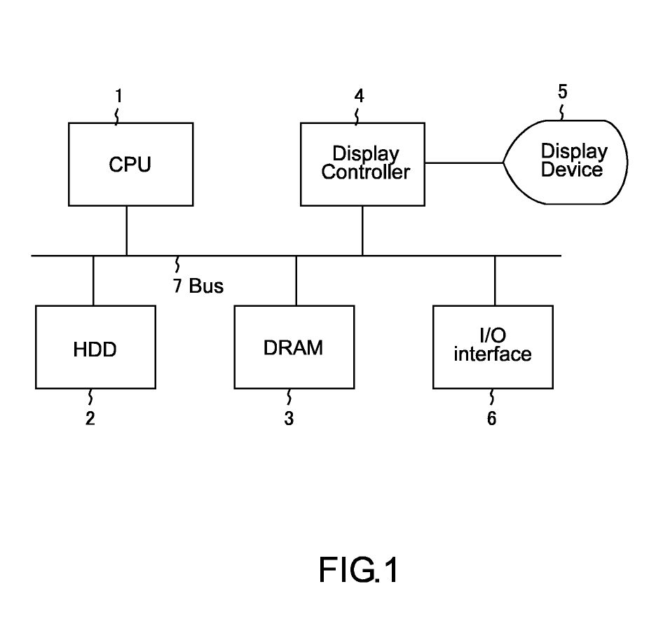

With reference to FIG. 1, a computer system according to an embodiment of the present invention includes the customary components including a CPU 1, a hard disk drive (HDD) 2, a dynamic random access memory (DRAM) 3, a display controller 4 coupled to a display/monitor device 5, and other input/output (I/O) interfaces such as a keyboard/mouse controller and a network interface. The HDD 2 and the DRAM 3 provide examples of computer readable storage devices that can be utilized to store and retrieve computer programs as explained below. Computer readable storage devices may include other storage mediums such as a CD-ROM, a DVD-ROM and a USB memory device. In this embodiment, the HDD 2 includes computer program products, in which a computer-implemented method according to the present embodiment is embodied. The computer program products comprise computer codes. The computer codes are loaded onto the DRAM 3 and are executed by the CPU 1 so that the computer system performs the computer-implemented method of the present embodiment as described hereinafter.

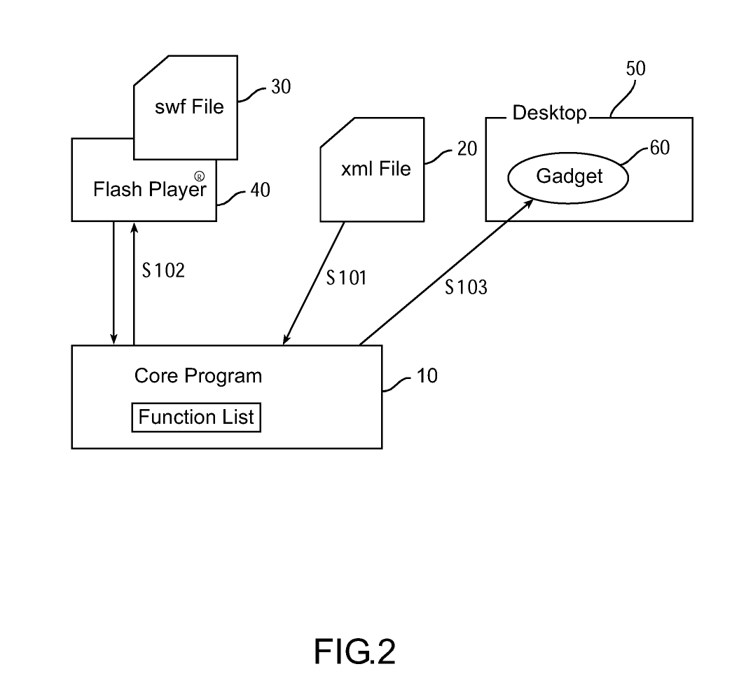

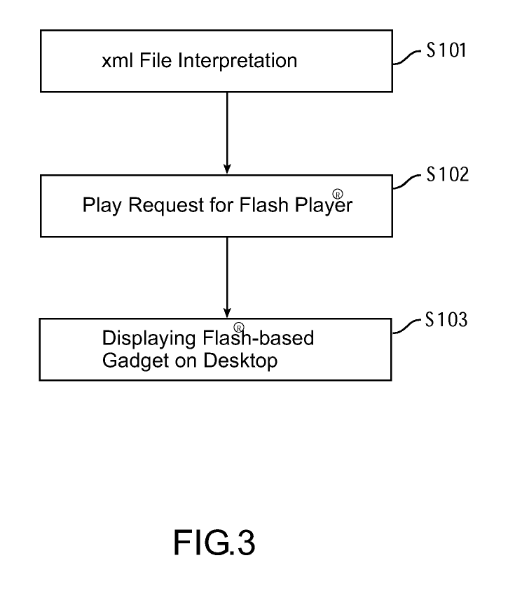

With reference to FIGS. 2 and 3, the HDD 2 includes at least a core program 10, an xml file 20, an swf file 30 and a Flash Player® 40. The computer-implemented method of the present embodiment is implemented by the core program 10 and so on and displays a Flash®-based user interface as a gadget 60 on a desktop 50 of the user's computer system.

In this embodiment, the core program 10 is stored in a predetermined directory which further includes a subdirectory “gadget.” The “gadget” directory includes “01” subdirectory, in which the xml file 20, the swf file 30 and so on, as illustrated herein:

```
/core.exe (core program 10)
/gadget/
/gadget/01/gadget.xml (xml file 20)
/gadget/01/gadget.ico
    .
    .
/gadget/01/gadget.swf (swf file 30)
```

The xml file 20 is a definition file that includes definition statements such as a statement of a name of the swf file 30, as illustrated below:

```
  <?xml version=”1.0” encoding=”Shift_JIS” ?>
− <gadget type=”standalone” version=”1.02”>
    <swf type=“main”>weather.swf</swf>
    <title>weather forecast</title>
    <list>true</list>
    <delete>false</delete>
  − <menu>
    <fix>true</fix>
    <config>true</config>
    <config_filename>config.html</config_filename>
    <help>true</help>
    <close>true</close>
    <help_url>http://desktop.xxxx.co.jp/DT3/GADGET/weather.-
    html</help_url>
    </menu>
  </gadget>
```

The “type” attribute in “gadget” tag indicates a type of the gadget 60 based on the swf file 30, and the “version” attribute indicates a version of the gadget 60. The “swf” tag indicates a filename of the swf file 30. The “title” tag indicates a title of the gadget 60; the title is used in a menu or gadget selection dialog box. The “list” tag indicates whether the title is listed in the menu. The “fix” tag indicates whether the gadget 60 is fixed on the foreground of the desktop 50. The “config” tag indicates whether there is a setting dialog box to be shown. The “config_filename” tag indicates a filename of an html file for the setting dialog box. The “help” tag indicates whether there is a help file. The “help-url” indicates a URL of the help file.

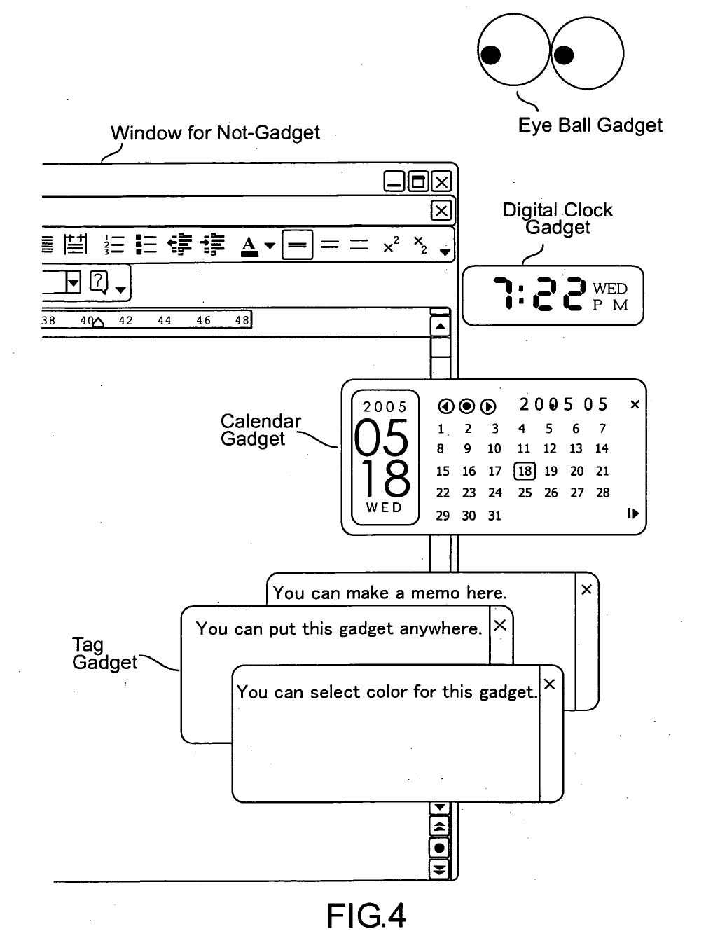

With reference to FIG. 3, the core program 10 interprets the xml file 20 to obtain the filename of the swf file 30 (S101). Next, the core program 10 requests the Flash Player® 40 to play the swf file 30 on the basis of the interpretation of the xml file 20 (S102). In response to the swf file 30 played by the Flash Player® 40, the core program 10 displays the gadget 60, i.e. Flash®-based user interface, on the desktop 50 (S103). Visual user interfaces based on the Flash® technologies allow various visual and easy expressions, as illustrated in FIG. 4. The illustrated gadgets of FIG. 4 are different from a normal application program of a Window-based operating system (OS) such as Windows XP® and have no windows.

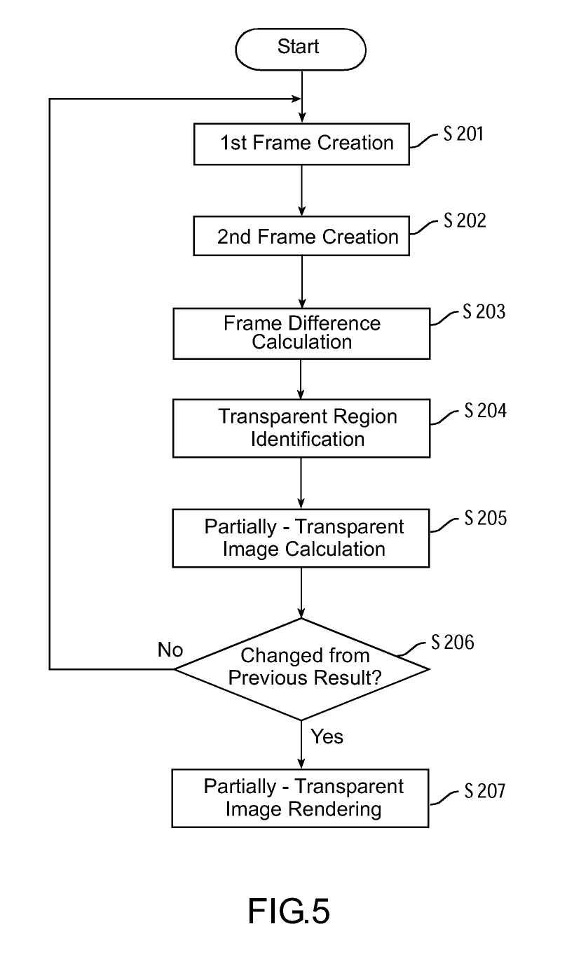

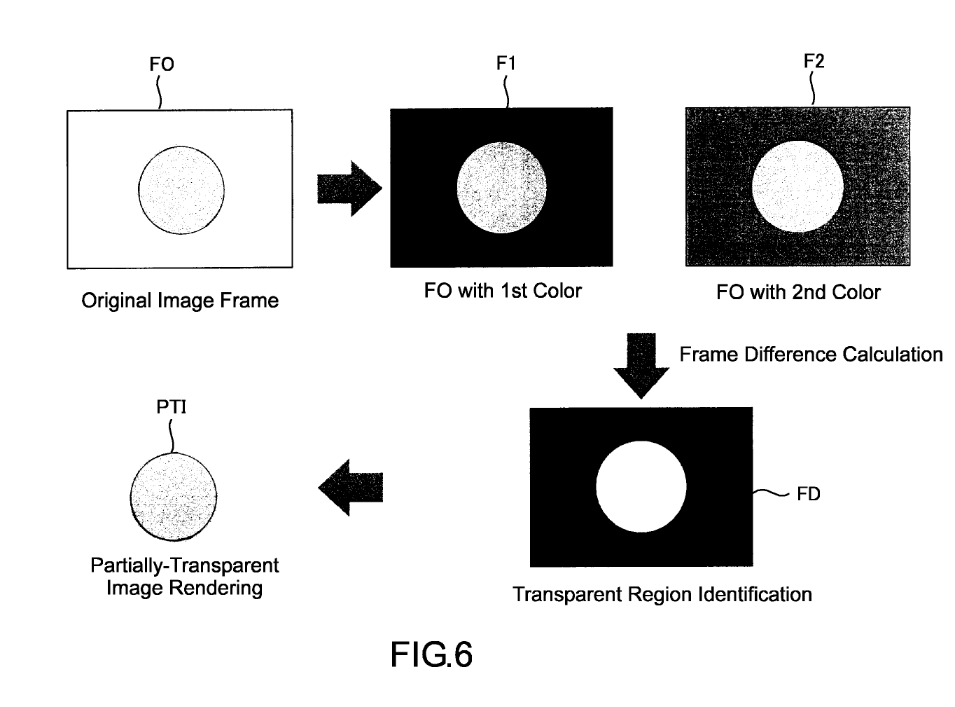

Furthermore, the illustrated gadgets are visually-transparent in part so as to have smooth edges. The partially-transparent appearances can be realized as illustrated in FIGS. 5 and 6.

The swf file 30 played by the Flash Player® comprises a plurality of original image frames, each of which includes a visually-transparent region. In order to display the gadget 60 on the desktop 50, the core program 10 carries out, for each original image frame, a process cycle shown in FIG. 5. In detail, the core program 10 blends one of the original image frames FO with a first color to create a first frame F1 (S201). In this embodiment, the first color is “black.” Next, the core program 10 blends the original image frame FO with a second color to create a second frame F2 (S202). In this embodiment, the second color is “white” and is different from the first color by a predetermined value which is referred to as a color difference in this embodiment. Next, the core program 10 calculates a frame difference FD between the first frame F1 and the second frame F2 (S203). As the frame difference FD includes a region which has the color difference, the core program 10 identifies the region as the transparent region of the original image frame FO (S204). Based on the identification, the core program 10 determines a partially-transparent image from the original image frame FO and the transparent region (S205). Next, the core program 10 of the present embodiment compares the determined partially-transparent image of a current cycle with the determined partially-transparent image of a previous cycle immediately before the current cycle (S206). If there is any change, the core program 10 renders the partially-transparent image as one appearance of the gadget 60 on the desktop 50 (S207). Thereafter, the core program 10 carries out the above-mentioned process steps S201 to S206 for the next original image frame. On the other hand, if there is no change between the current partially-transparent image and the previous partially-transparent image, the core program 10 goes back to the step S201 without carrying out the rendering step S207 for the current partially-transparent image. The core program 10 may derive alpha channel information of the original image frame FO from the frame difference FD and the color difference so that the partially-transparent image is calculated from the original image frame FO by using the alpha channel information.

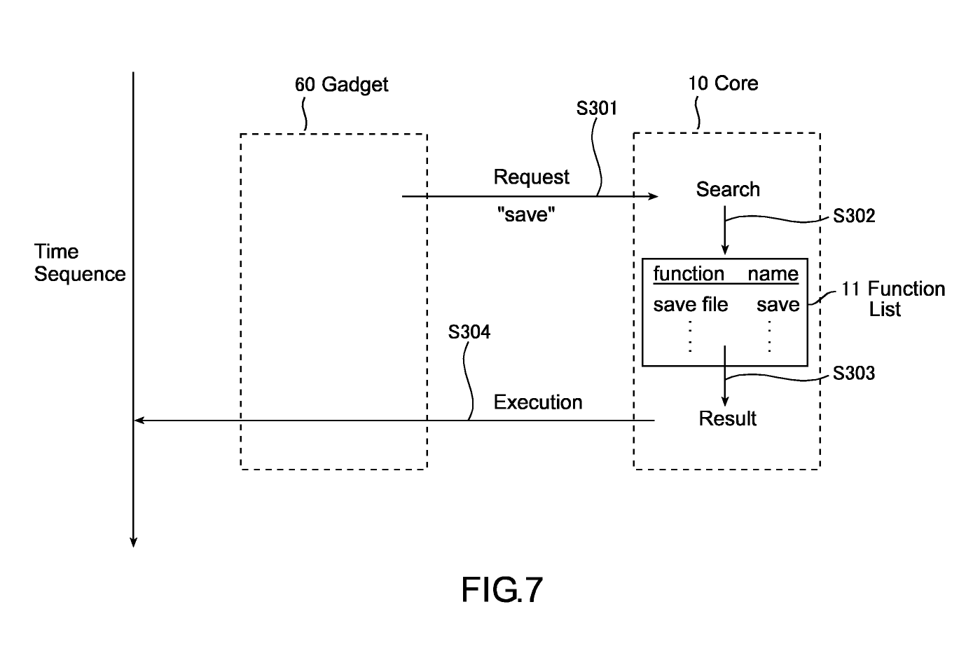

With reference to FIGS. 2 and 7, the core program 10 of this embodiment includes a function list that includes various functions predefined in association with keywords, respectively. The keywords of the present embodiment are FSCommands issued by the played swf file 30, i.e. gadget 60. However, the present invention is not limited thereto. For example, similar behavior may be realized by using the basis of Action Script 2 or Action Script 3 or External I/F technologies, depending upon version of Flash® technologies.

When received a keyword from the gadget 60, the core program 10 selects one of the predefined functions in connection with the received keyword from the function list 11 and executes the selected function. More in detail, as shown in FIG. 7, the gadget 60 sends a request by using a function name “save” (S301). When received the request, the core program 10 searches the related function from the function list 11 (S302) to obtain the function “save file” as the search result (S303). Then, the core program 10 saves a file (S304).

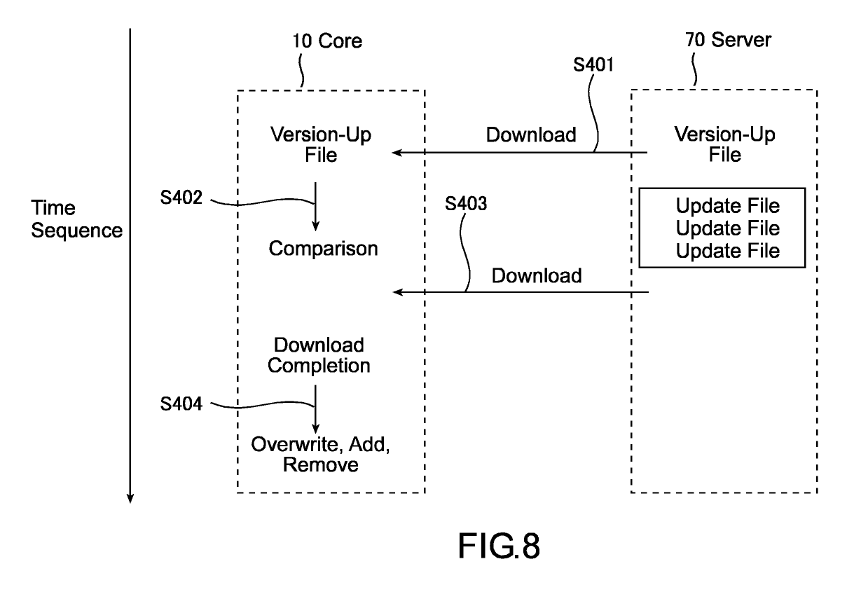

With reference to FIG. 8, the core program 10 of the present embodiment has a self version-up function. In detail, the core program 10 downloads a file list (S401) to compare it with the current file (S402). As the result, if necessary, the core program 10 downloads an update file (S403) and carries out the following process such as overwrite, add or remove process (S404).

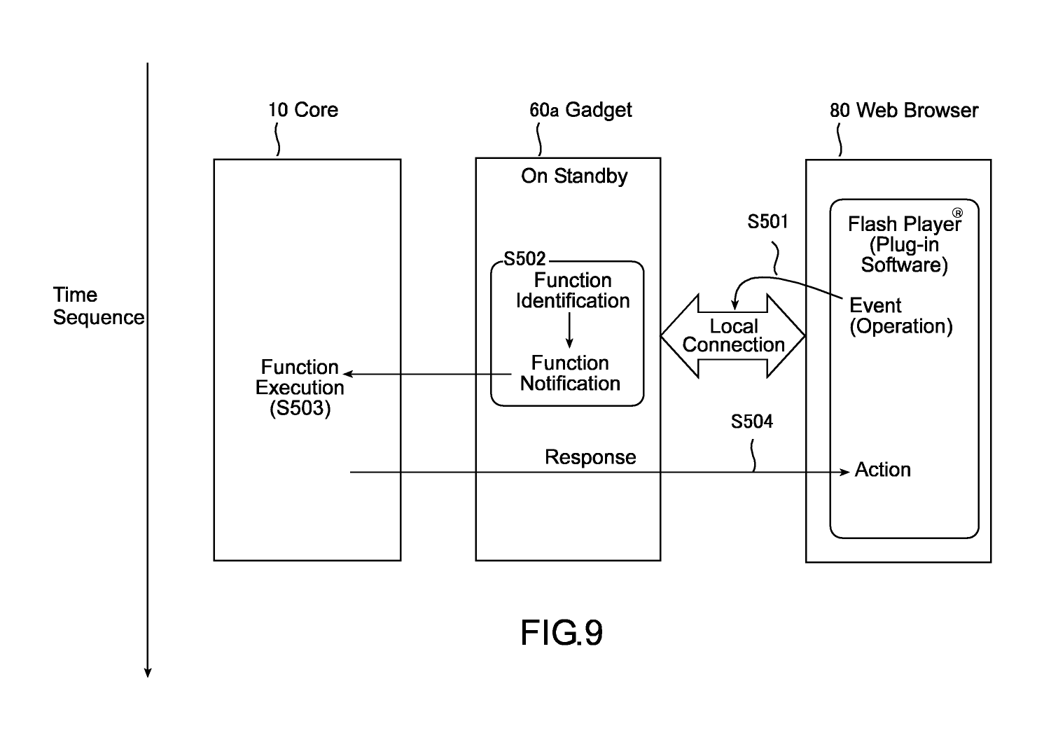

With reference to FIG. 9, a gadget 60a can communicate a Flash®-based object shown within a Web browser 80. As well known, the Flash Player® serves as a plug-in software for the Web browser 80 and plays an swf file. The gadget 60a is also based on the swf file played by the Flash Player® and can communicate another swf file played the Flash Player® within the Web browser 80 by using a Local Connection technique.

In detail, the gadget 60a is in a standby state as its initial state. When the Web browser 80 displays a web page including a particular Flash® content, the particular Flash® content starts to communicate the gadget 60a through a Local Connection. When a predetermined operation is carried out, the event is notified to the gadget 60a through the Local Connection (S501). When notified of the event, the gadget 60a identifies a function corresponding to the event and then notifies the core program 10 of the identified function (S502). The core program 10 executes the notified function (S503) and, if necessary, replies a response to the particular Flash® content shown in the Web browser 80 (S504).

As a combination of the above-mentioned examples, a pseudo drag-and-drop operation can be realized. The pseudo drag-and-drop operation is of an object included in a Flash® content, wherein the object is moved from a window of the Web browser 80 out of the window of the Web browser 80 in accordance with the movement of the mouse pointer. The Flash® content is a first swf file played by the Flash Player® upon a request by the Web browser 80 and is shown within the window of the Web browser 80.

In this embodiment, a special gadget for monitoring the Flash® content is executed in advance so that the core program 10 can obtain the state of the Flash® content and a click event for the object included in the Flash® content by using the Local Connection between the Flash® content and the special gadget. Therefore, when the special gadget obtains an occurrence of the click event from the Flash® content through the Local Connection, the core program 10 can be notified of the click event from the special gadget. Also, the core program 10 can receives an identification of the Flash® content through the special gadget to determine a second swf file in connection with the first swf file by using the identification of the Flash® content, wherein the second swf file provides a gadget serving as an alternative object which has an appearance same as the object included in the Flash® content displayed within the window of the Web browser 80.

When the Flash® content is shown, the core program 10 identifies the second swf file. When detecting a click event on the object of the Flash® content, the core program 10 requests the Flash Player® to play the second swf file. The core program 10 displays the alternative object at a position of a mouse pointer so that the displayed alternative object is dragged by the pointer of the mouse. The alternative object is moved in accordance with the mouse pointer until a drop event is detected. Thus, the pseudo drag-and-drop operation is realized. In this embodiment, after requesting the Flash Player® to play the second swf file, the core program 10 notifies it to the Flash® content, i.e. the played first swf file, to request the Flash® content to eliminate the object from the Flash® content.

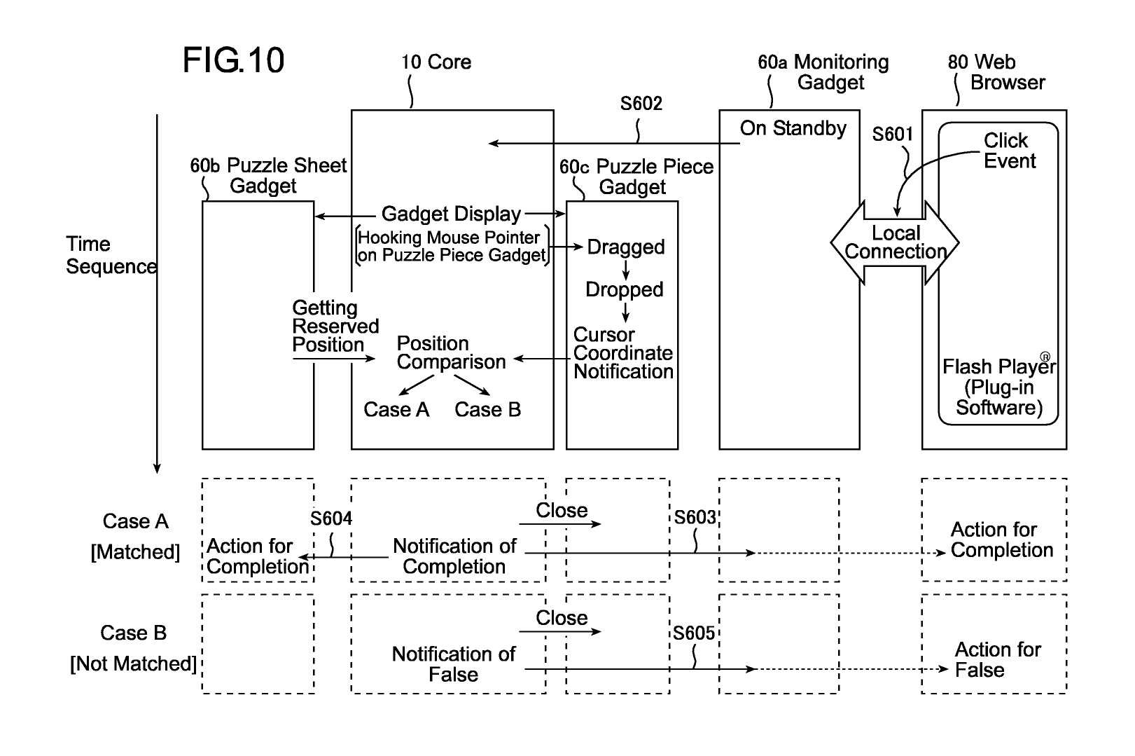

With reference to FIG. 10, next explanation will be made about an example of the pseudo drag-and-drop operation according to the present embodiment. The explanation relates to “puzzle” and is comprised of the core program 10 and three gadgets: a monitoring gadget 60a for monitoring the Flash® content displayed within the Web browser 80; a puzzle sheet gadget 60b providing a puzzle sheet on the desktop 50; and a puzzle piece gadget 60c providing a puzzle piece on the desktop 50. In this example, the puzzle piece of the puzzle piece gadget 60c is an alternative object for the object included in the Flash® content.

First, the monitoring gadget 60a is executed and is in a standby state. The monitoring gadget 60a may have no appearance. Namely, the gadget 60a may have completely-transparent appearance. When the Flash® content is displayed within the Web browser 80, the monitoring gadget 60a and the Flash® content start to communicate each other through a Local Connection therebetween. When detecting a click event on the object of the Flash® content (S601), the monitoring gadget 60a notifies the core program 10 of the occurrence of the click event (S602). In response to the notification, the core program 10 displays the puzzle sheet gadget 60b and the puzzle piece gadget 60c, wherein the mouse pointer is hooked on the puzzle piece gadget 60c. Namely, the puzzle piece gadget 60c is displayed so that it is dragged. In response to the mouse operation, the puzzle piece gadget 60c is moved until a drop event occurs. When the drop event occurs, the puzzle piece gadget 60c notifies the core program of the cursor coordinates. Then, the core program 10 obtains a reserved position on the puzzle sheet gadget 60b, wherein the reserved position is a position where the puzzle piece gadget 60c should be dropped. The core program 10 compares the reserved position and the cursor coordinates, i.e. a position where the puzzle piece gadget 60c is actually dropped. If the result of the comparison shows that the dropped position is matched with the reserved position, the core program 10 closes the puzzle piece gadget 60c. In addition, the core program 10 notifies a puzzle completion to the Flash® content and the puzzle sheet gadget 60b (S603 and S604) so that the Flash® content and the puzzle sheet gadget 60b carry out actions for completion, respectively. If the result of the comparison shows that the dropped position is not matched with the reserved position, the core program 10 closes the puzzle piece gadget 60c and notifies the Flash® content of the false of the puzzle completion (S605) so that the Flash® content carries out an action for false.

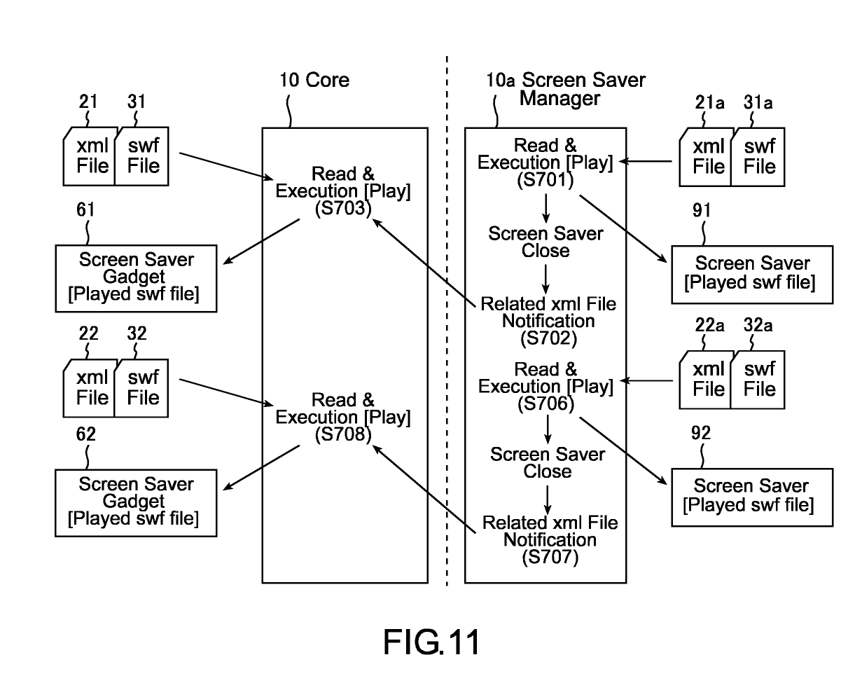

With reference to FIG. 11, a novel screen saver system can be built by using the above-mentioned Flash®-based user interface. The screen saver system according to the present embodiment comprises the core program 10 and a screen saver manager 10a. The screen saver manager 10a has the same functions as the core program 10 in addition to the general screen-saver managing functions, e.g. detecting of a mouse event and closing of a screen saver. The screen saver 91 is embodied as an swf file 31a played by the Flash Player®, which is requested to play the swf file 31a by the screen saver manager 10a. Namely, the screen saver 91 of the present embodiment is based on the Flash® technologies. After closing the Flash®-based screen saver 91 upon the detection of the mouse event, the screen saver manager 10a passes its position to the core program 10. The core program 10 requests the Flash Player® to play another swf file 31. The swf file 31 provides a Flash®-based screen saver gadget 61 similar to or in connection with the screen saver 91. By using the screen saver gadget 61, it is possible to conduct a user to a particular web site upon closing the screen saver 91.

In detail, the screen saver manager 10a reads an xml file 21a and requests the Flash Player® to play the swf file 31a (S701) so that the screen saver 91 is executed. When detecting a mouse event, the screen saver manager 10a closes the screen saver 91 and then notifies the core program 10 of a predetermined message through an inter-process communication between the screen saver manager 10a and the core program 10, wherein the predetermined message has information about a related xml file (S702). In response to the notification, the core program 10 reads an xml file 21 and requests the Flash Player® to play the swf file 31 (S703) so that a screen saver gadget 61 is displayed.

Two or more screen savers may be executed simultaneously. For example, the screen saver manager 10a also reads an xml file 22a and requests the Flash Player® to play the swf file 32a (S706) so that the screen saver 92 is executed. When detecting a mouse event, the screen saver manager 10a closes the screen saver 92 and then notifies the core program 10 of a predetermined message through an inter-process communication between the screen saver manager 10a and the core program 10, wherein the predetermined message has information about a related xml file (S707). In response to the notification, the core program 10 reads an xml file 22 and requests the Flash Player® to play the swf file 32 (S708) so that a screen saver gadget 61 is displayed.

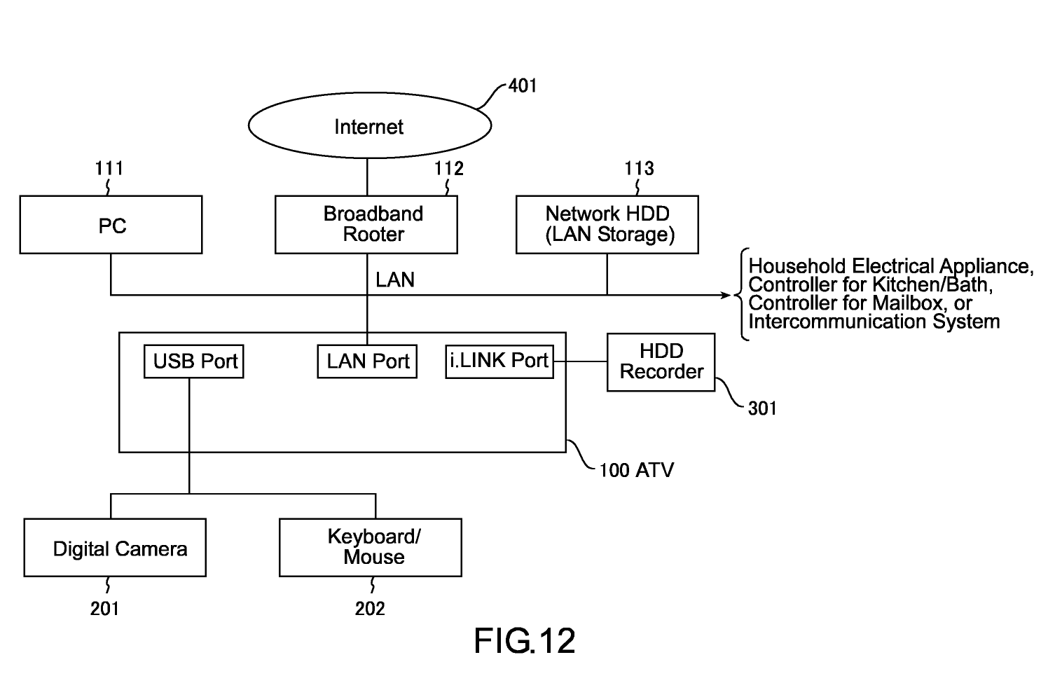

The present invention further realizes a novel advanced television (ATV). As shown in FIG. 12, an ATV 100 according to an embodiment of the present invention comprises a local area network (LAN) port and is coupled to a personal computer (PC) 111, a broadband rooter 112 and a network HDD 113 through a LAN. The ATV 100 can receive various movie signals or other data signals from the Internet 401 through the broadband rooter 112. The ATV 100 may be coupled through the LAN to various instruments such as a household electrical appliance, a controller for kitchen/bath, a controller for mail box, or an intercommunication system. The ATV 100 may have other I/O ports such as i.LINK port or USB port. For example, to the i.LINK port, a HDD recorder 301 is coupled; to the USB port, a digital camera 201 and a keyboard/mouse are coupled.

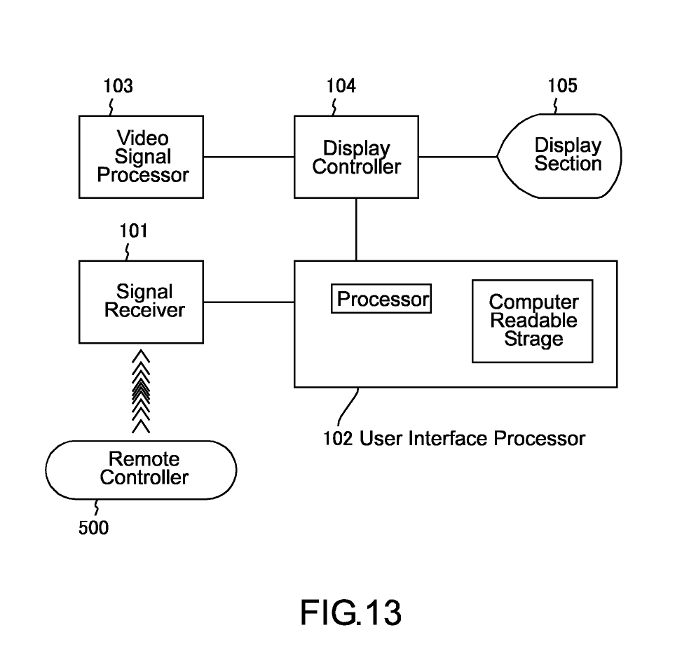

With reference to FIG. 13, the ATV 100 of the present embodiment comprises a signal receiver 101, a user interface processor 102, a video signal processor 103, a display controller 104 and a display section 105. The signal receiver 101 is configured to receive signals from a remote controller 500 to notify the user interface processor 102 of the received signals. The user interface processor 102 is configured to produce Flash®-based user interface data in response to the received signals. In detail, the user interface processor 102 comprises a processor and a computer-readable storage device coupled to the processor. The computer-readable storage device stores the above-mentioned core program and etc. so that the user interface processor 102 can produce Flash®-based user interface data in a similar manner as explained above. The video signal processor 103 is configured to produce internal video signals. The display controller 104 is configured to cause the display section 105 to display video contents corresponding to the internal video signals and Flash®-based user interfaces corresponding to the Flash-based user interface data.

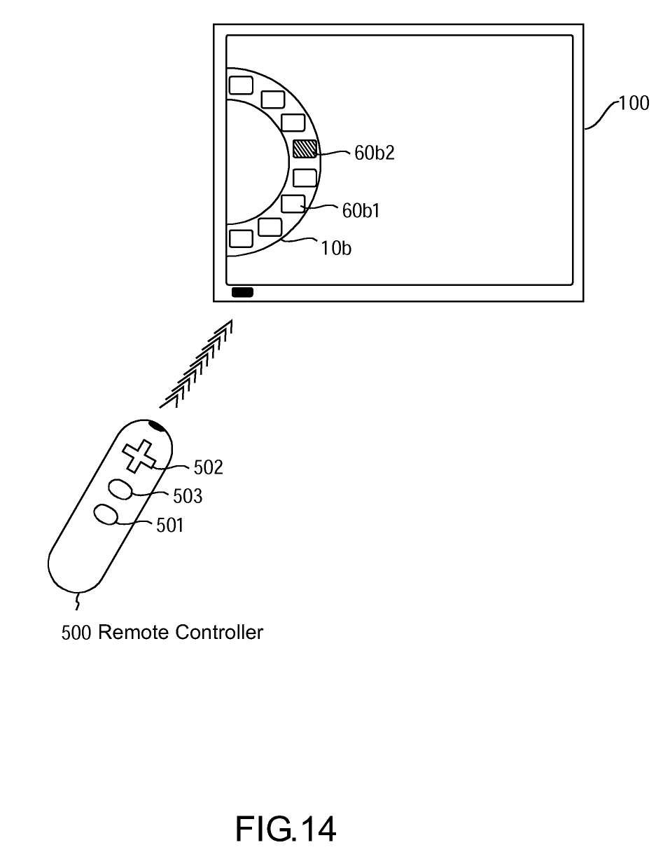

With reference to FIG. 14, when a button 501 of the remote controller 500 is pushed by a user, the ATV 100 displays a launcher 10b which is composed of a part of a core program. On the launcher 10b, multiple item gadgets 60b1, 60b2 are arranged. The user selects one of the item gadgets 60b1, 60b2 by using a cross-key button 502. In the illustrated example, the item gadget 60b2 is selected. Then, the user pushes a button 503 so that a function linked to the item gadget 60b2 is executed. The above-explained technique can provide flexibility on menu design because appearances of item gadgets can be freely created and links of the item gadgets to functions can be also freely determined.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A computer-implemented method for displaying a pseudo drag-and-drop operation of an object from a window of a Web browser out of the Web browser's window on a desktop of a computer system, a first swf file being played by a Flash Player® upon a request by the Web browser to provide a particular content within the Web browser's window, the object being at least one part of the particular content, the method comprising;
detecting a click event on the object of the particular content;
identify a second swf file in connection with the first swf file;
requesting the Flash Player® to play the second swf file in response to the detection of the click event, the played second swf file providing an alternative object, the alternative object having an appearance same as the object displayed within the Web browser's window;
displaying the alternative object at a position of a mouse pointer upon the detection of the click event, the displayed alternative object being dragged by the pointer of the mouse; and
moving the alternative object in accordance with the mouse pointer until a drop event is detected.

2. The method according to claim 1, further comprising notifying the played first swf file of the play of the second swf file to order the played first swf file to eliminate the object from the particular content.

3. The method according to claim 1, further comprising requesting the Flash Player® to play a third swf file, the played third swf file monitoring the play of the first swf file and communicating with the played first swf file by using a Local Connection between the played first file and the played third swf file, wherein:
the detecting comprises receiving a notification of the click event from the played third swf file, the played third swf file obtaining an occurrence of the click event from the played first swf file through the Local Connection; and
the identifying comprises receiving an identification of the played first swf file through the played third swf file and determining the second swf file by using the identification of the played first swf file.

4. A computer program product embodied on a computer readable medium for displaying a pseudo drag-and-drop operation of an object from a window of a Web browser out of the Web browser's window on a desktop of a computer system, a first swf file being played by a Flash Player® upon a request by the Web browser to provide a particular content within the Web browser's window, the object being at least one part of the particular content, the computer program product comprising;
computer code for detecting a click event on the object of the particular content;
computer code for identify a second swf file in connection with the first swf file;
computer code for requesting the Flash Player® to play the second swf file in response to the detection of the click event, the played second swf file providing an alternative object, the alternative object having an appearance same as the object displayed within the window of the Web browser;
computer code for displaying the alternative object at a position of a mouse pointer upon the detection of the click event, the displayed alternative object being dragged by the pointer of the mouse; and
computer code for moving the alternative object in accordance with the mouse pointer until a drop event is detected.

5. The computer program product according to claim 4, further comprising computer code for notifying the played first swf file of the play of the second swf file to order the played first swf file to eliminate the object from the particular content.

6. The computer program product according to claim 4, further comprising computer code for requesting the Flash Player® to play a third swf file, the played third swf file monitoring the play of the first swf file and communicating with the played first swf file by using a Local Connection between the played first file and the played third swf file, wherein:
the computer code for detecting comprises computer code for receiving a notification of the click event from the played third swf file, the played third swf file obtaining an occurrence of the click event from the played first swf file through the Local Connection; and
the computer code for identifying comprises computer code for receiving an identification of the played first swf file through the played third swf file and computer code for determining the second swf file by using the identification of the played first swf file.

7. A system comprising a display device and a computer-readable storage device, the computer-readable storage device storing a Web browser, a Flash Player®, a first swf file, a second swf file, and a core program, wherein:
the first swf file comprises code for providing a particular content within a window of the Web browse when played by the Flash Player® upon a request by the Web browser, wherein the particular content comprises an object;
the second swf file comprises code for providing an alternative object when played by the Flash Player® through the core program, wherein the alternative object has an appearance same as the object displayed within the Web browser's window; and
the core program comprises:
computer code for detecting a click event on the object of the particular content;
computer code for identify the second swf file in connection with the first swf file;
computer code for requesting the Flash Player® to play the second swf file in response to the detection of the click event;
computer code for displaying the alternative object at a position of a mouse pointer upon detection of the click event, the displayed alternative object being dragged by the pointer of the mouse; and
computer code for moving the alternative object in accordance with the mouse pointer until a drop event is detected.

8. The system according to claim 7, wherein the core program further comprises computer code for notifying the first swf file of the play of the second swf file, and the first swf file further comprises codes for eliminating the object from the particular content when notified of the play of the second swf file.

9. The system according to claim 7, further comprising a third swf file that comprises code for monitoring the play of the first swf file, code for communicating with the played first swf file by using a Local Connection between the played first file and the played third swf file and code for obtaining an occurrence of the click event from the played first swf file through the Local Connection, wherein:
the core program further comprises computer code for requesting the Flash Player® to play the third swf file;
the computer code for detecting comprises computer code for receiving a notification of the click event from the played third swf file; and
the computer code for identifying comprises computer code for receiving an identification of the played first swf file through the played third swf file and computer code for determining the second swf file by using the identification of the played first swf file.

10. An apparatus comprises:
a display section;
a video signal processor configured to produce internal video signals;
a user interface processor configured to produce Flash®-based user interface data; and
a display controller configured to cause the display section to display video contents corresponding to the internal video signals and Flash®-based user interfaces corresponding to the Flash-based user interface data.

11. The apparatus according to claim 10, wherein:
the user interface processor comprises a processor and a computer-readable storage device coupled to the processor;
the computer-readable storage device stores a core program, a Flash Player®, an swf file and an xml file including at least one statement concerning the swf file;
the swf file comprises code for providing at least one of the Flash®-based user interfaces; and
the core program comprises: instructions for interpreting the xml file; instructions for requesting the Flash Player to play the swf file on the basis of the interpretation of the xml file; instructions for reserving a particular area on the display section; and instructions for displaying on the particular area a Flash®-based user interface based on the played swf file.

12. A combination of a remote controller and an apparatus, the remote controller being configured to transmit a selection signal, the apparatus comprising:
a signal receiver configured to receive the selection signal from the remote controller;
a display section; and
a user interface processor configured to cause the display section to display Flash®-based user interfaces and, in response to the received selection signal, to select one of the Flash®-based user interfaces to carry out a predetermined process according to the selected Flash®-based user interface.

13. The combination according to claim 12, wherein:
the user interface processor comprises a processor and a computer-readable storage device coupled to the processor;
the computer-readable storage device stores a core program, a Flash Player®, swf files and xml files each including at least one statement concerning one of the swf files;
each of the swf files comprises code for providing one of the Flash®-based user interfaces; and
the core program comprises: instructions for interpreting one of the xml files; instructions for requesting the Flash Player® to play at least one of the swf files on the basis of the interpretation of the xml file; instructions for reserving on the display section a particular area for the played swf file; and instructions for displaying on the particular area a Flash®-based user interface based on the played swf file.
